(19) United States
(12) Patent Application Publication
(10) Pub. No.: US 2003/0028703 A1
(43) Pub. Date: Feb. 6, 2003

(54) DISK ARRAY DEVICE CAPABLE OF PROVIDING LOGICAL DISKS FOR EACH HOST COMPUTER REGARDLESS OF LIMITATION OF THE OTHER HOST COMPUTERS

(76) Inventor: HIROHIKO KOIKE, TOKYO (JP)

Correspondence Address: FOLEY & LARDNER, WASHINGTON HARBOUR, 3000 K STREET N W SUITE 500, WASHINGTON, DC, 200075109

(21) Appl. No.: 09/464,412

(22) Filed: Dec. 16, 1999

(30) Foreign Application Priority Data
Dec. 16, 1998 (JP) 10-358035

(51) Int. Cl. G06F 12/10

(52) U.S. Cl. 711/4; 711/114; 711/203

(57) ABSTRACT

A disk array device comprises interfaces each of that is connected to a host computer through a connection port. Each of the interfaces has a conversion table that stores relationships between logical disks included in the disk array device and logical units defined by the host computer. The host computer uses LBAs (Logical Block Addresses) for the logical units to access the logical disks. The interface converts the LBAs for the logical units into LBAs for the logical disks with reference to the conversion table. A controller of disk array device controls a reading section or a writing section to access the logical disks in response to the LBAs for the logical disks.

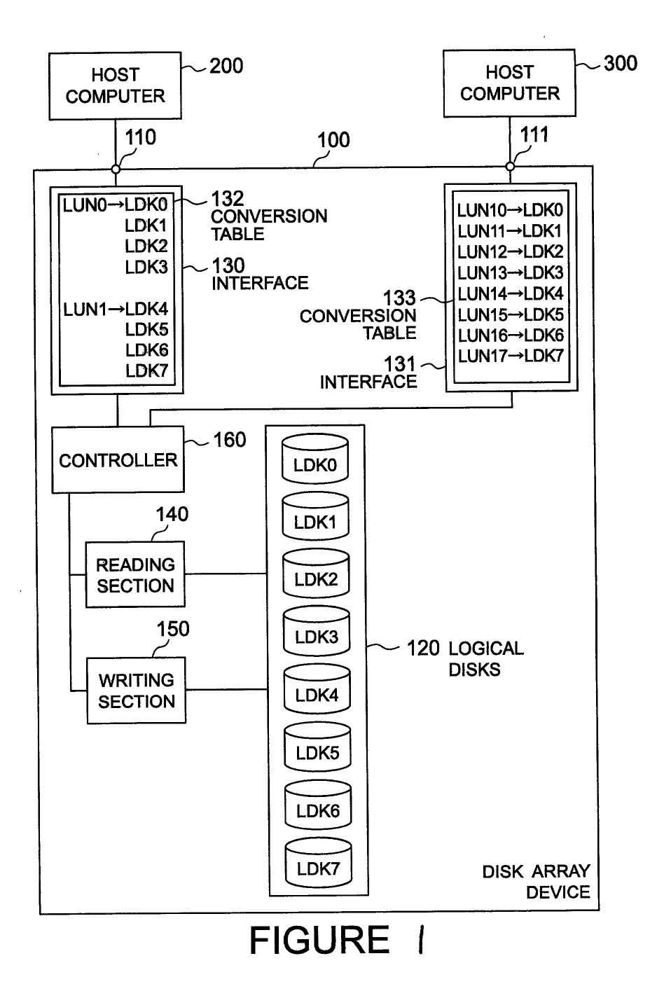

### BACKGROUND OF THE INVENTION

This invention relates to a disk array device which is connected to a plurality of host computers and has a plurality of logical disks, particularly, relates to a disk array device which provides each host computer with logical disks corresponding to logical units which are defined by the host computer regardless of other host computers.

Recently, disk array devices have become used with various information processing systems. Each of the disk array devices includes one or more physical disks, such as hard disks, and is connected to a plurality of host computers used in each of the information processing systems. The physical disk(s) is (are) used as a plurality of logical disks in the information processing systems. Each of the host computers defines logical units each of that corresponds to one or more logical disks. That is, the host computer accesses to the logical units as substitutes for the logical disks.

Generally, each of the information processing systems has a limitation of the number of the logical units used therein and/or a limitation of the number of addresses for accessing to each of the logical units. For example, a propla system, which is one of mainframe computer (or general-purpose computer) systems allows the maximum of two hundreds fifty-six logical units. That is, the propla system can define two hundreds fifty-six or fewer logical units. When total capacity of the logical units used by the propla system becomes large, the performance of the propla system deteriorates. On the other hand, an NX system, which is an open system, made by NEC (Nippon Electric Corporation) allows the maximum of eight small capacity logical units since it is limited by software.

If a conventional disk array system is shared by the propla system and the NX system, it must be restricted by the NX system rather than the propla system. That is, the conventional array system must be handled as eight or fewer logical units in this case. This is because the NX system can not define nine of more logical units, while the propla system can define two hundreds fifty-six logical units.

Thus, the conventional array device provides the host computers connected thereto with the same logical units. That is, the conventional array device is used as being suitable for the lowest performance of the host computers connected thereto. Accordingly, there is a case where the conventional array device does not completely provide its performance for the host computers connected thereto.

### SUMMARY OF THE INVENTION

It is therefore an object of this invention to provide a disk array device capable of completely providing its performance for host computers connected thereto.

It is another object of this invention to provide a disk array device capable of providing different logical units for different host computers connected thereto.

It is still another object of this invention to provide a disk array device capable of being individually accessed by host computers connected thereto according to performance of them.

It is further still another object of this invention to provide a disk array device capable of being individually accessed by host computers connected thereto without being limited by the other host computers.

Other object of this invention will become clear as the description proceeds.

On describing the gist of this invention, it is possible to understand that a disk array device is connected to host computers and has a plurality of logical disks which form logical units accessed by the host computers.

According to the gist of this invention, the disk array device comprises an interface which is connected to each of the host computers and which has a conversion table. The conversion table stores relationships between the logical units and the logical disks to make possible access from the host computer connected to the disk array to the logical disks.

According to another gist of this invention, a disk array device is connected to host computers and has a plurality of logical disks which form logical units accessed by the host computers. The disk array device comprises interfaces which are connected to the host computers and have conversion tables, respectively. Each of the conversion tables stores relationships between the logical units and the logical disks. The logical units are decided by each of the host computers. The interfaces make possible access from the host computers to the logical disks.

### BRIEF DESCRIPTION OF THE DRAWING

FIGURE is a block diagram of a disk array device according to a preferred embodiment of this invention.

### DESCRIPTION OF THE PREFERRED EMBODIMENT

Referring to a FIGURE, description will be directed to a disk array device according to a preferred embodiment of this invention.

In the FIGURE, the disk array device 100 is connected to two host computers (or host processors) 200 and 300 at connection ports 110 and 111, respectively.

The disk array device 100 comprises logical disk section 120 that has logical disks LDK0-LDK7 and that is used by both of the host computers 200 and 300. Two interfaces 130 and 131 are connected to the connection ports 110 and 111 and have conversion tables 132 and 133, respectively, to communicate with the host computers. A reading section 120 is connected to the logical disk section 110 to read memorized data from the logical disk section 110. A writing section 130 is connected to the logical disk section 110 to write writing data into the logical disk section 130. A controller 160 is connected to the reading section 140, the writing section 150, and the interfaces 130 and 140. The controller 160 controls the reading section 140 and the writing section 150 to control access to the logical disk section 120 in response to requests supplied from the host computers 200 and 300 through the interfaces 130 and 131.

The logical disks LDK0-LDK7 are formed by one or more physical disks, such as hard disks. Needless to say, each of the logical disks LDK0-LDK7 may be formed by one or more physical disks. Each of the logical disks LDK0-LDK7 has storage regions or blocks (not shown) that LBAs (Logical Block Addresses) are assigned thereto.

The host computers 200 and 300 individually define logical units which are logical devices and addressable from the host computers 200 and 300 to access the logical disk section 120. In this embodiment, the host computer 200 defines two logical units LUN0 and LUN1 while the host computer 300 defines seven logical units LUN10-LUN17. The logical units are substitutes for the logical disks LDK0-LDK7. The logical units LUN0 and LUN1 substitute for the logical disks LDK0-LDK3 and LDK4-LDK7, respectively. The logical units LUN10-LUN17 substitute for the logical disks LDK0-LDK7, respectively.

Each of the logical units has logical storage regions or blocks (not shown) that LBAs are assigned thereto. The logical storage regions of the logical units are corresponding to the storage regions of the logical disks LDK0-LDK7.

The host computers 200 and 300 use the LBAs for the logical units when it accesses to the logical storage regions of the logical disks LDK0-LDK7. Accordingly, it is necessary to convert the LBAs for the logical units into the LBAs for the logical disks LDK0-LDK7 when the host computers 200 and 300 access to the logical disk section 120. Then, the conversion tables 132 and 133 are used for converting the LBAs for the logical units into the LBAs for the logical disks LDK0-LDK7.

The conversion tables 132 and 133 memorize relationships between the LBAs for the logical units and the LBAs for the logical disks LDK0-LDK7. That is, the conversion table 132 relates the LBAs for the logical unit LUN0 with the LBAs for logical disks LDK0-LDK3 and relates the LBAs for logical unit LUN1 with the LBAs for the logical disks LDK4-LDK7. Similarly, the conversion table 133 relates the LBAs for each of the logical unit LUN10-LUN17 with the LBAs for each of the logical disks LDK0-LDK7. These contents memorized in the conversion tables 132 and 133 may be set and changed by the use of a maintenance terminal (not shown) connected to the disk array device 100.

The interfaces 130 and 131 converts the LBAs for the logical units into the LBAs for the logical disks LDK0-LDK7 with reference to the conversion tables 132 and 133, respectively.

Next, an operation of the disk array device shown in the FIGURE will be described soon.

The host computer 200 produces a first access request and sends it to the interface 130 through the connection port 110. The first access request includes an LBA of α1 for either the logical unit LUN0 or LUN1.

The interface 130 receives the first access request sent from the host computer 200 and detects the LBA of α1. Then the interface 130 refers the conversion table 132 and converts the LBA of α1 for the logical unit LUN0 or LUN1 into an LBA of β1 for the logical disk LDK0-LDK3 or LDK4-LDK7. For example, when the LBA of α1 is for the logical unit LUN0 and is smaller than the number of the logical storage regions of the logical disk LDK0, the LBA of β1 has been assigned to the storage region of the logical disk LDK 0. Moreover, when the LBA of α1 is for the logical unit LUN1 and is bigger than the number of the logical storage regions of the logical disk LDK4 and smaller than a sum of the numbers of the logical stage regions of logical disks LDK4 and LDK 5, the LBA of β1 has been assigned to the storage region of the logical disk LDK 5. The interface 130 produce a second access request including the LBA of β1 to supply it to the controller 160.

The controller 160 controls either the reading section 140 or the writing section 150 in response to the second access request to access to the logical disk section 120.

If the second access request is a read command, the controller 160 controls the reading section 140 to read the memorized data from the logical disks indicated by the LBA of β1. The controller 160 transmits the memorized data read out from the logical disks to the host computer 200 through the interface 130.

If the second access request is a write command, the controller 160 controls the writing section 140 to write the writing data into the logical disks indicated by the LBA of β1. The writing section 150 writes the writing data supplied from the host computer 200 through the interface 130 into the logical disks indicated by the LBA of β1.

Similarly, the host computer 300 produces a third access request and sends it to the interface 131 through the connection port 111. The third access request includes an LBA of α2 for one of the logical units LUN10-17.

The interface 131 receives the third access request sent from the host computer 300 and detects the LBA of α2.

The interface 131 receives the first access request sent from the host computer 300 and detects the LBA of α2. Then the interface 131 refers the conversion table 132 and converts the LBA of α2 for one of the logical unit LUN10-17 into an LBA of β2 for the corresponding one of the logical disks LDK0-LDK7. For example, when the LBA of α2 is for the logical unit LUN0, the LBA of β2 has been assigned to the storage region of the logical disk LDK 0. The interface 131 produce a forth access request including the LBA of β2 to supply it to the controller 160.

The controller 160 controls either the reading section 140 or the writing section 150 like a manner mentioned above in response to the forth access request to access to the logical disk section 120. The reading section 140 and the writing section 150 operate like ways mentioned above.

As mentioned above, the host computers 200 and 300 access different logical units. Accordingly, the host computers 200 and 300 do not give restrictions each other and can access all of the storage regions of the logical disks LDK0-LDK7.

While this invention has thus for been described in conjunction with the preferred embodiment thereof, it will readily be possible for those skilled in the art to put this invention into practice in various other manners. For example, the disk array device may have three or more interfaces and connection ports connected thereto. Moreover, the disk array device may have nine or more logical disks.

What is claimed is:

1. A disk array device connected to host computers and having a plurality of logical disks which form logical units accessed by said host computers, said disk array device comprising:
an interface connected to each of said host computers and having a conversion table which stores relationships between said logical units and said logical disks for making possible access from the host computer connected thereto to said logical disks.

2. A disk array device claimed in claim 1, wherein said conversion table stores combinations of first logical block addresses of the logical units and second logical block addresses of the logical disks as the relationships between said logical units and said logical disks.

3. A disk array device claimed in claim 2, wherein said interface converts an input logical block address which is supplied from the host computer connected thereto and which corresponds to one of the first logical block addresses into an output logical block address which is one of the second logical block addresses with referring to said conversion table.

4. A disk array device claimed in claim 1, said disk array further comprising:
a reading unit connected to said logical disks for reading first data memorized in said logical disks therefrom;
a writing unit connected to said logical disks for writing second data into said logical disks; and
a controller connected to said interface, said reading unit, and said writing unit for controlling said reading unit and said writing in response to a request supplied from said interface.

5. A disk array device connected to host computers and having a plurality of logical disks which form logical units accessed by said host computers, said disk array device comprising:
interfaces connected to said host computers and having conversion tables, respectively, each of said conversion tables storing relationships between said logical units and said logical disks, said logical units defined by each of said host computers, said interfaces making possible access from said host computers to said logical disks.

6. A disk array device claimed in claim 5, wherein each of said conversion tables stores combinations of first logical block addresses of the logical units and second logical block addresses of the logical disks as the relationships between said logical units and said logical disks.

7. A disk array device claimed in claim 6, wherein each of said interface converts an input logical block address which is supplied from the host computer connected thereto and which corresponds to one of the first logical block addresses into an output logical block address which is one of the second logical block addresses with referring to its conversion table.

8. A disk array device claimed in claim 5, said disk array further comprising:
a reading unit connected to said logical disks for reading first data memorized in said logical disks therefrom;
a writing unit connected to said logical disks for writing second data into said logical disks; and
a controller connected to said interfaces, said reading unit, and said writing unit for controlling said reading unit and said writing in response to a request supplied from each of said interfaces.
